(19) United States
(12) Patent Application Publication
(10) Pub. No.: US 2005/0099984 A1
(43) Pub. Date: May 12, 2005

(54) Broadcast signal delivery system for use with wireless technology

(75) Inventors: Ayinde Alakoye, Los Angeles, CA (US); John A. Kalenowsky, Palarine, IL (US)

Correspondence Address: GREER, BURNS & CRAIN, LTD., Suite 2500, 300 South Wacker Drive, Chicago, IL, 60606, US

(73) Assignee: Ayinde Alakoye

(21) Appl. No.: 10/983,868

(22) Filed: Nov. 8, 2004

Related U.S. Application Data
(60) Provisional application No. 60/517,896, filed on Nov. 7, 2003.

(51) Int. Cl. H04Q 7/00

(52) U.S. Cl. 370/338

(57) ABSTRACT

A system for delivering media content streams to users of wireless communication devices comprising at least one wireless communication device, at least one at least one media content source capable of delivering at least one media content stream, and at least one switching center for receiving media content requests from the wireless communication devices and delivering a media content stream from the media content source to the wireless communication device.

### RELATED APPLICATION

This application claims priority under 35 USC. § 120 based on Ser. No. 60/517,896, filed Nov. 7, 2003.

### BACKGROUND OF THE INVENTION

This invention relates to mobile wireless communications systems such as cellular or mobile telephone networks, and more specifically to a system which provides the capability for the user to access entertainment content through a mobile receiver connected to such a network.

The ability to dial a telephone number and listen to a recorded message has been available since the days of rotary dial telephones (e.g. dialing WEATHER, 932-8437, to listen to a weather forecast, or another number for the time). At one time these were “local” calls (and typically “free”), occasionally sponsored by a local business, such as a bank or the local telephone company.

Customer access to such messages was typically accomplished by specially configuring a ‘line’ in the telephone company's central office switch to not require ringing, nor that it be ‘picked up’ (equivalent to lifting the receiver for a standard telephone call) to be completed. The dialing of the number was sufficient to ‘complete the call’ and connect the calling party, enabling them to hear the message. The special configuration of this line could also allow more than one caller to be connected at the same time (no busy signals) and serve multiple callers simultaneously. In early forms of this service, the message was typically recorded on magnetic tape, usually in a continuous loop and in a cartridge that could be easily removed and replaced with another cartridge that contained an updated recording of the message. The message was not limited to something recorded, though. It was possible for it to be any audio source that could be connected to the specially configured telephone line with proper signal levels (including a radio receiver).

As technology has advanced, such services have evolved to ‘pay-per service’ programs, typically “900” (or “1-900”) numbers for regional or national areas. These services can provide information and services that run the gamut from simple informational items like time, weather, winning lottery numbers, sports results, and joke of the day, to interactive services such as daily wake-up calls, personalized psychic readings or daily horoscopes, to advanced services such as chat lines, dating services, or virtual gaming. These audio information services no longer have to be entirely resident in the telephone company's central office switch; they can be provided by separate pieces of equipment that are connected to the central office switch.

U.S. Pat. No. 6,721,403, incorporated herein by reference, discloses a system which distributes radio programming through the public switched telephone network (PSTN). The bandwidth restrictions of the PSTN limit the sound quality of such systems, and the systems place a significant additional load on the PSTN.

Widespread use of cellular telephones has stimulated demand for new types of cellular services. At the same time, the spread of Internet radio broadcasting demonstrates the technical and economic feasibility of alternate modes of distributing radio programming.

Thus, there is a need for providing the capability to deliver high-quality broadcast radio programming and other media content to cellular telephone users without need for cellular telephones or cellular networks with broadband capability.

There is also a need for making radio programming available in locations where cellular service is available but radio reception is either unavailable or marginally available.

There is also a need for providing cellular telephone users with access to types of media content that would otherwise be typically available only in fixed locations, such as large collections of recorded music.

There is still another need for making a single device such as an ordinary cellular telephone serve the functions of several other devices, such as a portable radio, a personal CD player, and/or a personal MP3 player, giving users access to several types of media and services without compelling them to carry multiple devices around with them.

### SUMMARY OF THE INVENTION

The above-identified needs are met or exceeded by the present system for delivering radio programming and other types of media content to wireless service subscribers through their wireless devices.

In one embodiment, the programming or media content is provided in “real time” to the wireless service subscribers by a system which contains at least one portable wireless communication device, at least one media content source capable of delivering at least one media content stream, and at least one switching center for receiving media content requests from wireless communication devices and delivering media content streams from media content sources to the wireless communication devices.

In another embodiment, the system establishes a connection between a portable wireless communication device and a switching center, transmits a media content request from the portable wireless communication device to the switching center, and selects a media content source and a media content stream according to the media content request.

### BRIEF DESCRIPTION OF THE DRAWINGS

FIG. 1 is a schematic diagram illustrating the operation of an embodiment of the present invention that uses a radio or television receiver as a media content source;

FIG. 2 is a schematic diagram illustrating the operation of an embodiment of the present invention that uses separate system components to perform traditional switching functions and to connect wireless devices to media content sources;

FIG. 3 is a schematic diagram illustrating the operation of an embodiment of the present invention that uses a computer located at the premises of the media content provider as a media content source; and

FIG. 4 is a schematic diagram illustrating the operation of an embodiment of the present invention that uses a computer located at the site of the wireless switch as a media content source.

### DESCRIPTION OF PREFERRED EMBODIMENT

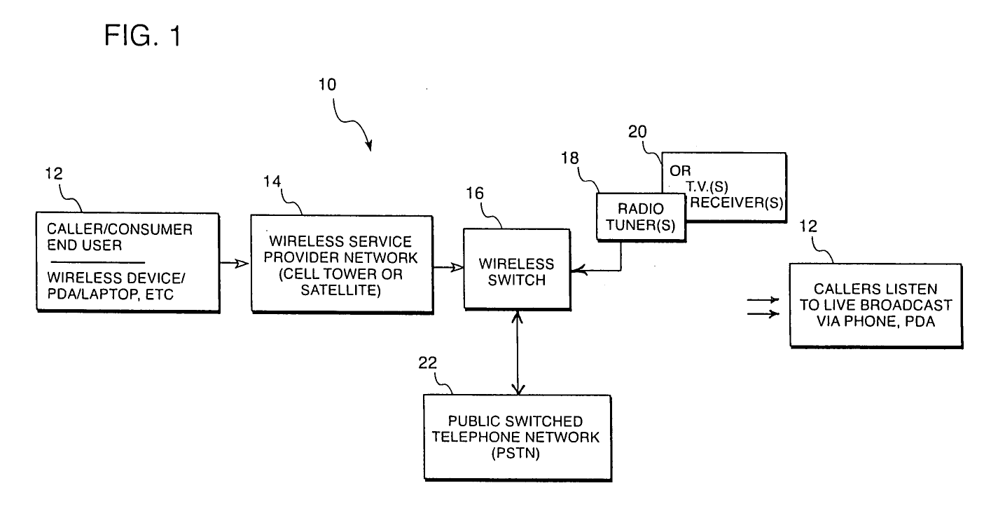

Users may access this system by entering a service request number, i.e., a special code on the wireless device's keypad such as “#1003” or “*80.” The service request number is processed by the wireless carrier's wireless switch (FIG. 1). The wireless switch is a hub that routes all calls for the wireless carrier. It routes calls for the present invention to a receiver (a preset AM/FM tuner or television receiver) that is physically placed near the wireless switch. Hooking up the receiver to the wireless switch allows consumers to listen to the broadcast via wireless devices. Alternatively, if the wireless carrier incorporates the present invention into the cellular telephone's menu system, the user may access it by making appropriate selections from the menus.

The function of the receiver can also be performed by any other type of media content source, such as an audio recorder. For example, an audio recorder could play a weather report or a traffic report recorded in a continuous loop.

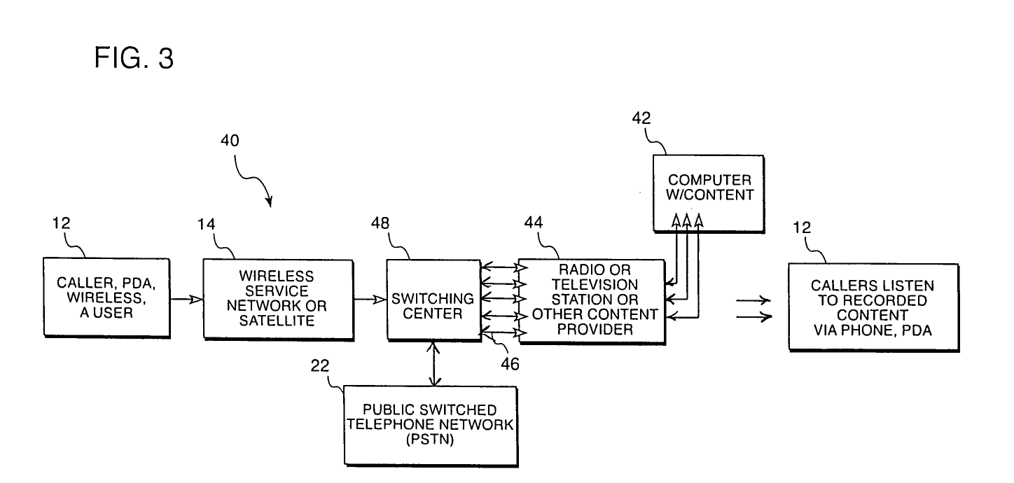

An additional way to route calls is to run multiple communication lines from the wireless switch to the broadcast station (FIG. 3). At the broadcast station, the communication lines are connected to computers. Selected content can be placed and periodically updated on these computers where it is available to callers who want to listen to it. Content can include a “joke of the day” from a premiere host, celebrity sound bites, geographically specific traffic conditions and other data. This content is not limited. Multiple computers may be necessary to allow increased volume for the selected content delivery. This content will be delivered back through the communication lines to the wireless switch and finally to the caller.

Referring now to FIG. 1, a first preferred embodiment of the present system is generally designated 10. In the system 10, a cellular telephone user initiates a request for service by entering a service request number on a cellular telephone 12.

The present system may be used with any type of wireless service and portable wireless communication device that is capable of presenting audio media content to its user. The term “cellular telephone” is used herein to refer to any such wireless device, and includes personal digital assistants (PDA's), handheld computers, laptop computers, and other mobile wireless devices connectable to subscription wireless services. This term should not be construed as a limitation on the types of wireless services and devices which the present invention may use.

The service request number is transmitted through a cellular carrier's proprietary network 14 made up of cellular tower, satellites or similar network components which allow remote users to communicate wirelessly with a central provider, naturally more than one tower and or satellite are contemplated as making up the network 14. Next, the request is ultimately forwarded to a wireless switch or switching center 16 which detects the service request number and accordingly establishes a connection between the cellular telephone 12 and a corresponding media content source such as a radio tuner 18 or television receiver 20.

An objective of the system is enabling the user of the cellular telephone 12 to listen to a media content stream such as programming currently being broadcast by a radio or television station to which the corresponding radio tuner 18 or television receiver 20 is tuned. Preferably, the content is received by the user of the cellular telephone 12 in a “real time” basis, or generally simultaneous with the actual broadcast, taking into account normal transmission delays.

It is contemplated that the wireless switch 16 has access to more than one radio tuner 18 and/or television receiver 20, enabling the user to select among several radio and/or television stations by dialing different service request numbers. Thus, each service request number corresponds to a particular radio station or channel television. Alternatively, the system 10 may be configured to allow a user to dial a single service request number to establish contact with the wireless switch 16, and then choose among several stations interactively by replying to a series of queries from the wireless switch 16. Such queries may take the form of menus from which the user makes selections, prompts to enter free-form input, or a combination of these and other interactive systems known in the art.

It is also contemplated that the system 10 may incorporate more than one wireless switch 16, for example, to increase the number of users it can service concurrently. In a system 10 with multiple wireless switches 16, each wireless switch 16 may be enabled to communicate with each radio tuner 18 and/or television receiver 20, for example, by cross-connecting each switch to each source.

It is also contemplated that the wireless switch 16 may interact verbally with the user by means of sound recordings and/or speech synthesis. That is, the wireless switch 16 may present menus or prompts to the user by playing sound recordings or employing speech synthesis, and/or the user may respond by speaking to a speech recognition capability implemented in the wireless switch.

Once the connection between the cellular telephone 12 and the radio tuner 18 or the television receiver 20 is established, the delivery of the requested media content stream continues until the user presses the cellular telephone's “end call” button, puts the connection “on hold” to make a call or take an incoming call, or selects a different media content source.

Predictably, multiple users will want to listen to the same media content source at the same time. The wireless switch 16 can accommodate this need by connecting any number of users to a single media content source.

A user may also use a cellular telephone to make a telephone call in the conventional manner. When the wireless switch 16 detects a dialed number that is not a service request number it routes the number to a public switched telephone network (PSTN) 22 as it would if the present system were not present.

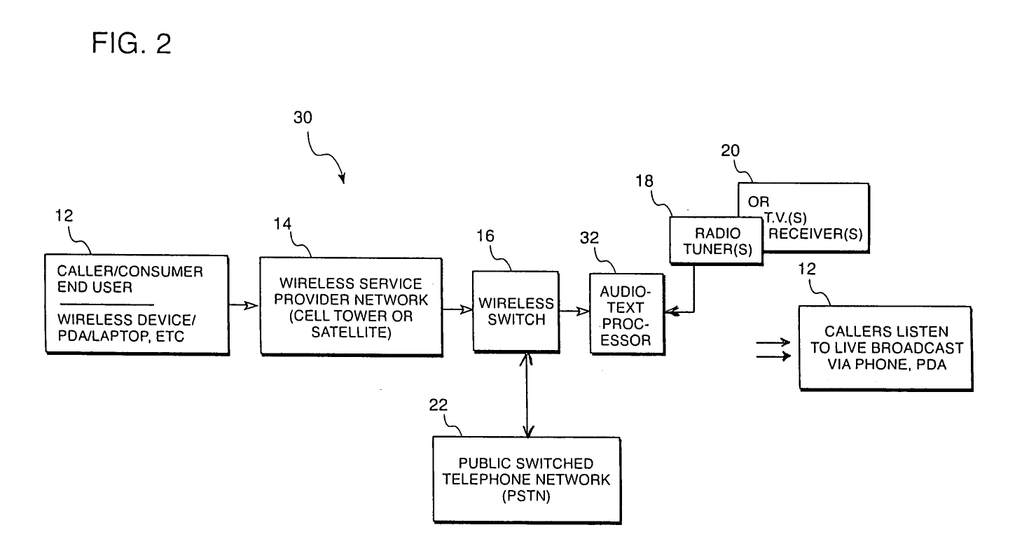

Referring now to FIG. 2, a second embodiment of the present system 10 is generally designated 30. Components shared with the system 10 in FIG. 1 are designated with the same reference numbers. Thus, the system 30 includes the cellular telephone 12, the proprietary network 14, the wireless switch 16, the radio tuner 18, the television receiver 20, and the public switched telephone network 22. A difference between the systems 10 and 30 is that the switching function is divided between two components, the wireless switch 16 and an audiotext processor 32. The wireless switch 16 performs its traditional function of interfacing the cellular network 14 to the PSTN 22, but forwards service request numbers to the audiotext processor 26.

One suitable type of the audiotext processor 32 is the “pulseteleserve” audiotext system provided by Pulse Software and Consulting, Inc. in Richmond Hill, Ontario, Canada. It typically consists of a digital computer with voice processing boards that interface with the wireless switch and software that controls its operation. The audiotext processor 32 establishes a connection between the cellular telephone 12 and a media content source such as a radio tuner 18 or television receiver 20. These audiotext systems, with proper programming and configuration, are very flexible in the types of services that they can provide. Connection of audio sources is greatly simplified. The use of prior art magnetic tape players has generally been replaced by computer programs that can record the audio information to a data file and reproduce that audio information in a totally electronic fashion. External non-prerecorded programs, such as the audio from a radio/TV broadcast, can be provided by a receiver tuned to the specific frequency or channel of the broadcast, and connected to an input of the audiotext system. While it is contemplated that the present systems 10 and 30 are focused on the transmission of audio signals, it is envisioned that video signals may be transmittable as well with evolution of improved wireless networks.

Referring now to FIG. 3, a third preferred embodiment is generally designated 40. Components shared with the system 10 are designated with the same reference numbers, and include the cellular telephone 12, the proprietary network 14, and the public switched telephone network 22. Some or all of the media content streams are delivered by a digital computer 48 which is programmed to store recordings of media content such as radio programs, individual songs, or informational messages, and to deliver such recordings on demand.

The computer 42 is located on the premises of a content provider 44, typically a radio or television broadcasting station, and is connected through a dedicated communication channel 46 to a switching center 48, which may be either the wireless switch 16 illustrated in FIG. 1, or the combination of the wireless switch 16 and the audiotext processor 32 illustrated in FIG. 2.

It will be understood by those skilled in the art that a single digital computer can be programmed to deliver many media content streams concurrently to different users, and that the capacity of the system 40 to deliver multiple media content streams can be increased by using a more powerful computer, using additional computers, or both.

The digital computer 42 may be programmed to provide additional services to the user. For example, it may be programmed to store a list of songs or other media content which an individual user likes, enabling that user to select a song from the list with an abbreviated selection procedure. For another example, it may be programmed to store a list of CDs and other copyrighted works for which an individual user has purchased reproduction rights, enabling that user to select a song from that list without paying a per-play royalty which the user would otherwise be charged. These two features in combination enable the present system to perform the essential functions of a personal player like the Apple iPod.

Also, two or more computers may be configured to deliver different types of media content or media content from different sources. For example, the system 40 may incorporate two or more computers which deliver content on behalf of different broadcasters or other content providers.

Since the digital computer 42 is capable of delivering many media content streams (for example, many different songs or programs), the switching center 48 must give the digital computer some type of command to identify the media content stream that a user is requesting. It may do this by generating an appropriate command in response to the user's selection, or by making a connection between the user's cellular telephone 12 and the computer 42 which enables the user to select a media content stream by interacting directly with the computer.

When a user requests a recorded media content stream, the content typically is presented from the beginning. It follows that if several users concurrently request the same media content, the system must deliver a separate media content stream to each one, beginning at the instant when that user's request is made. This contrasts with the live media content delivered by the radio tuner 18 and the television receiver 20 in the system 10, which deliver a media content stream in real time, and thus can deliver a single media content stream for each radio station or television channel to any number of users.

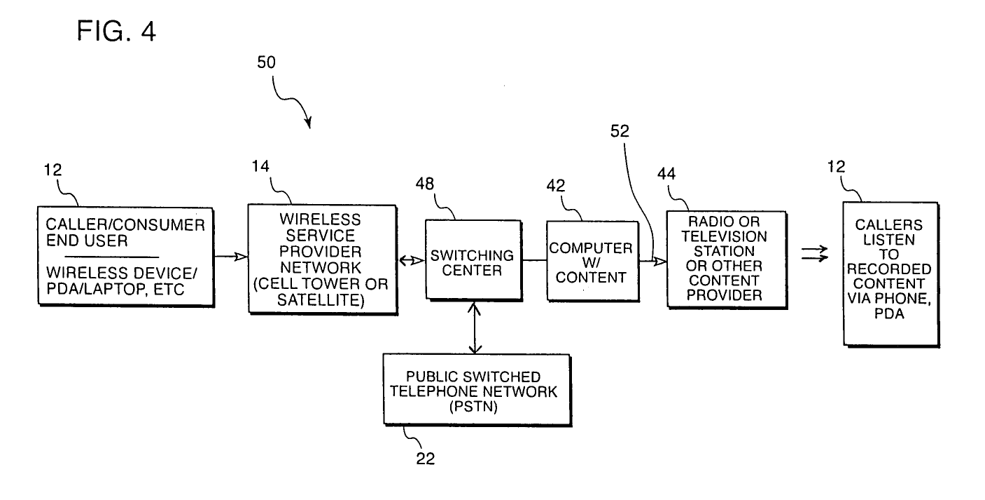

Referring now to FIG. 4, a fourth preferred embodiment is generally designated 50. Components shared with the system 40 in FIG. 3 are the cellular telephone 12, the proprietary network 14, the public switched telephone network 22, the switching center 48, the content provider 44, and the computer 42. A main distinguishing feature of the system 50 is that the computer 42 is located on the wireless carrier's premises, close to the switching center 48. Thus, the content provider 44 downloads content to and controls the computer 42 from its premises through a low-bandwidth communication channel 52.

It will be appreciated by those skilled in the art that this embodiment eliminates the need for the communication channel 46 in FIG. 3 which requires a continuous connection, high bandwidth, and zero-delay transmission, replacing it with a low-bandwidth communication channel 52 which is needed only intermittently, does not require high bandwidth, and is not sensitive to transmission delays. The low-bandwidth communication channel 52 may be implemented by a conventional Internet Protocol (IP) connection through the Internet.

Several preferred embodiments of the present invention have been described herein. It is to be understood, of course, that changes and modifications may be made in the embodiment without departing from the true scope and spirit of the present invention as defined by the appended claims.

1. A system for delivering media content streams to users of wireless communication devices, said system comprising:
at least one portable wireless communication device;
at least one media content source capable of delivering at least one media content stream; and
at least one switching center for receiving media content requests from said wireless communication device and delivering a media content stream from said media content source to said wireless communication device.

2. The system as defined in claim 1 wherein said portable wireless communication device is taken from a group comprising a cellular telephone, a personal data assistant capable of wireless communication, a handheld computer capable of wireless communication, and a laptop computer capable of wireless communication.

3. The system as defined in claim 1 wherein said switching center is a wireless switch.

4. The system as defined in claim 1 wherein said switching center is a subsystem comprising a wireless switch and an audiotext processor, said wireless switch connecting said portable wireless communication device to said audiotext processor and said audiotext processor performing at least part of the function of selecting a media content source and a unit of media content.

5. The system as defined in claim 1 wherein said switching center is configured so that a media content source is selected according to a service request number entered by the user.

6. The system as defined in claim 1 wherein at least one system component selected from a group comprising said portable wireless communication device's menu system, said wireless switch, an audiotext processor, and said media content source is configured so that a media content source and a media content stream are selected according to the user's responses to a series of at least one query presented by said at least one system component.

7. The system as defined in claim 1 wherein each said media content source is taken from a group comprising a radio tuner, a television receiver, an audio recording device, and a computer configured to deliver media content streams on demand.

8. The system as defined in claim 7 wherein said computer is configured to receive and store a list of preferred content for each user and to deliver media content streams selected from that list according to an abbreviated selection procedure.

9. The system as defined in claim 3 wherein said wireless switch performs the additional function of enabling the user of said wireless communication device to make and receive telephone calls through the public switched telephone network.

10. The system as defined in claim 4 wherein said wireless switch performs the additional function of enabling the user of said wireless communication device to make and receive telephone calls through the public switched telephone network.

11. A method for delivering media content streams to users of portable wireless communication devices, said method comprising the steps of:
establishing a connection between a portable wireless communication device and a switching center;
transmitting a media content request from said portable wireless communication device to said switching center;
selecting a media content source according to said media content request; and
delivering a media content stream from said media content source through said switching center to said portable wireless communication device.

12. The method as defined in claim 11 wherein a media content source is selected according to a service request number entered by a user.

13. The method as defined in claim 11 wherein a media content source is selected according to a user's responses to a series of at least one query presented through said wireless communication device.

14. The method as defined in claim 13 wherein said queries are presented to a user in visual form.

15. The method as defined in claim 13 wherein said queries are presented to a user in spoken form.

16. The method as defined in claim 13 wherein a user responds to said queries by pressing keys on said portable wireless communication device.

17. The method as defined in claim 13 wherein a user responds to said queries by speaking to said portable wireless communication device.
